(19) United States
(12) Patent Application Publication
(10) Pub. No.: US 2012/0020121 A1
(43) Pub. Date: Jan. 26, 2012

(54) CURRENT DETECTION CIRCUIT AND SWITCHING REGULATOR CIRCUIT

(75) Inventor: Yasuhiro Iino, Kawasaki (JP)

(73) Assignee: FUJITSU LIMITED, Kawasaki-shi (JP)

(21) Appl. No.: 13/185,934

(22) Filed: Jul. 19, 2011

(30) Foreign Application Priority Data
Jul. 20, 2010 (JP) 2010-162426

(51) Int. Cl. H02M 3/335; H02M 7/06

(52) U.S. Cl. 363/21.04; 363/126

(57) ABSTRACT

A current detection circuit that includes a winding part including a core provided on a switching element and a lead wire which is wound around the core, and a signal generation unit configured to generate a signal with a value having correlation to a current passing through the switching element based on a current passing through the lead wire.

### CROSS-REFERENCE TO RELATED APPLICATION

This application is based upon and claims the benefit of priority from the prior Japanese Patent Application No. 2010-162426 filed on Jul. 20, 2010, the entire contents of which are incorporated herein by reference.

### FIELD

The present invention relates to a current detection circuit configured to detect a current passing through a power supply.

### BACKGROUND

In recent years, semiconductor devices including a central processing unit (CPU), a field programmable gate array (FPGA), etc., which are used for a network apparatus, a server apparatus, and so forth have become sophisticated at a rapid pace. Accordingly, in semiconductor devices, operation voltages have decreased, while operation currents and processing speed have increased. Further, semiconductor devices have also been downsized. As a consequence, a power supply device supplies power with a low voltage and a large current to a load device including a semiconductor device and the like. Further, the power supply device should be downsized so as to complement and not to waste the downsizing of a semiconductor device.

Accordingly, one of the power supply devices that has been able to meet the above-described expectations includes a switching regulator circuit generating increased switching frequencies. The switching achieved by the switching regulator circuit is usually “hard switching” achieved through the use of a switching element (power semiconductor element). Therefore, high power noises (unnecessary radio waves) occur from the switching element due to the increased switching frequencies. A bead core is used to reduce the above-described power noises. The bead core is a bead-like core (iron core) with a through hole provided at the center part thereof. The bead core is provided on the switching element so that a lead wire through which a current controlled with the switching element passes physically perforates through the through hole of the bead core, for example. Without being limited to the switching regulator circuit, the bead core may be used for an electric circuit having to reduce power noises occurring due to the switching and the like.

On the other hand, detecting a current passing through an electric circuit including a power supply circuit and the like is important to manage and control a device including the electric circuit. When the electric circuit is the power supply circuit, the current passing through the electric circuit is a current passing through the load of the power supply circuit, that is, a load current. The current passing through the electric circuit is detected by measuring a voltage obtained at each of both ends of a resistor (i.e., a drop of the resistor) inserted in series with a part and the like of the electric circuit (on the output line of a power supply circuit when the power supply circuit is used as the electric circuit). However, when the voltage is decreased and the current is increased as described above, the consumption power of the resistor becomes equivalent to the product of the square of a current I and a resistor value R (I²·R) so that the power consumed by the resistor becomes significantly high. As a consequence, a relatively large amount of energy is wasted to measure the current.

For solving the above-described problems, the following technology has been available. According to the technology, a toroidal coil is provided on the terminal of a switching element, and the terminal is used as a primary winding and the winding of the toroidal coil is used as a secondary winding so as to detect a current passing through an electric circuit (see Japanese Unexamined Patent Application Publication No. 7-326530). Since the above-described technology allows for using the additionally provided toroidal coil as part of a current transformer (CT), it becomes possible to avoid wasting a relatively larger amount of power than that wasted in the case where the current detection is performed with a resistor.

However, since the size of each of parts such as the switching element, the distance between terminals, and so forth have been decreased, it is difficult to provide space for providing an additional toroidal coil in an electric circuit, the additional toroidal coil being specifically designed for the current transformer. In other words, detecting a current passing through a device with the toroidal coil specifically designed for the current transformer involves increasing the distance between the terminals of an element. As a consequence, the entire device is increased in size.

### SUMMARY

According to an embodiment, a current detection circuit includes: a winding part including a core provided on a switching element and a lead wire which is wound around the core; and a signal generation unit configured to generate a signal with a value having a correlation to a current passing through the switching element based on a current passing through the lead wire.

### BRIEF DESCRIPTION OF THE DRAWINGS

FIG. 1 illustrates a rough schematic of a winding and a signal generating circuit included in a current detection circuit.

FIG. 2 is a perspective view of the winding part illustrated in FIG. 1.

FIG. 3 is a circuit diagram of an exemplary electric circuit including the current detection circuit illustrated in FIG. 1.

FIG. 4 is an equivalent circuit diagram of the current detection circuit illustrated in FIG. 3.

FIG. 5 is a time chart illustrating exemplary electric operations of the electric circuit illustrated in FIG. 3.

FIG. 6 is a schematic view of an exemplary server including the current detection circuit illustrated in FIG. 1.

FIG. 7 is a schematic view of exemplary print boards that are installed in the server illustrated in FIG. 6.

### DESCRIPTION OF EMBODIMENTS

Hereinafter, embodiments of the present invention will be described with reference to the attached drawings. However, the present embodiment is not limited to the above-described embodiments, but may be modified in various ways within the spirit and scope thereof.

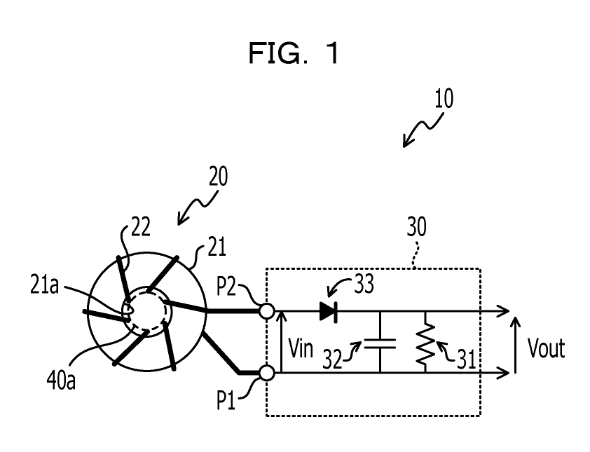

As illustrated in FIG. 1, a current detection circuit 10 according to an embodiment of the present invention includes a winding part 20 and a signal generation unit 30.

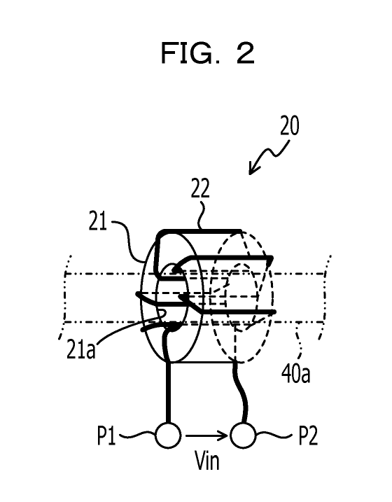

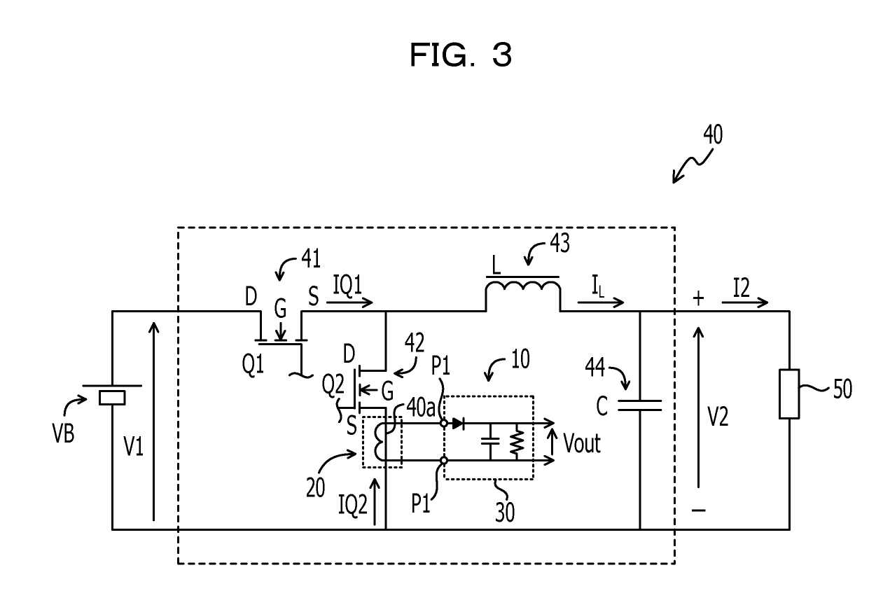

As illustrated in each of FIGS. 1 and 2, the winding part 20 includes a bead core 21 and a lead wire 22. The bead core 21, which includes a magnetic material (e.g., a ferrite magnetic material), is used to reduce power noises occurring from an electric circuit such as a switching regulator. The bead core 21 is cylindrical in form and includes a through hole 21a passing therethrough along the center axis thereof. That is, the bead core 21 is formed into a ring. A source terminal 40a of a low-side switching element 42 which will be described later perforates through the through hole 21a (see Japanese Patent No. 3458621, Japanese Examined Patent Application Publication No. 5-68818, Japanese Unexamined Patent Application Publication No. 2001-313215, etc.). On the other hand, the bead core 21 may not be formed into a ring so long as the current path of the switching element 42, of FIG. 3, perforates through the bead core 21.

The lead wire 22 is wound around the bead core 21 so that a toroidal core is formed. That is, the lead wire 22 is wound around the bead core 21 a plurality of times so that the lead wire 22 runs on the outer periphery of the bead core 21 along the center axis of the bead core 21, and further runs on the surface of the through hole 21a along the center axis of the bead core 21.

The signal generation unit 30 is a known smoothing circuit including a resistor 31, a capacitor 32, and a diode 33 as illustrated in FIG. 1. A terminal P1 is connected to one of the ends of the lead wire 22, and a terminal P2 is connected to the other end of the lead wire 22. That is, the terminals P1 and P2 are connected to the individual both ends of the lead wire 22. The resistor 31 is connected in series between the terminals P1 and P2. The capacitor 32 is connected in parallel with the resistor 31 with reference to the terminals P1 and P2 so that one of the ends of the capacitor 32 is connected between the terminal P1 and one of the ends of the resistor 31, and the other end of the capacitor 32 is connected between the terminal P2 and the other end of the resistor 31. The diode 33 is inserted between the terminal P2 and the other end of the capacitor 32 so that the anode of the diode 33 is connected to the terminal P2 and the cathode of the diode 33 is connected to the other end of the capacitor 32.

As a consequence, a voltage signal (a signal obtained by rectifying a current passing through the lead wire 22) Vout responsive to the current passing through the lead wire 22 is obtained at each of both ends of the resistor 31. The signal generation unit 30 outputs the voltage signals Vout obtained at the both ends of the resistor 31 as voltage signals.

As illustrated in FIG. 3, the current detection circuit 10 is applied to an electric circuit 40 including a high-side switching element (power semiconductor) 41, a low-side switching element (power semiconductor) 42, an inductor 43, and a capacitor 44. Each of the switching elements 41 and 42 is, for example, a metal oxide semiconductor field-effect transistor (MOSFET). The electric circuit 40 is a known “non-insulated step-down converter (step-down DC-DC converter)” configured to step down a DC voltage V1 of a direct-current (DC) power supply VB to convert the DC voltage V1 into a DC voltage V2, and applies the DC voltage V2 to a load device 50 including, for example, a CPU. At that time, a load current I2 is fed into the load device 50.

The electric circuit 40 is briefly described below. The high-side switching element 41, the inductor 43, and the capacitor 44 are connected in series with the DC power supply VB generating the DC voltage V1. The drain terminal of the high-side switching element 41 is connected to the positive electrode of the DC power supply VB, and the source terminal of the high-side switching element 41 is connected to one of the ends of the inductor 43. The other end of the inductor 43 is connected to one of the ends of the capacitor 44, and the other end of the capacitor 44 is connected to the negative electrode of the DC power supply VB. The both ends of the capacitor 44 are connected to the load device 50. The voltage V2 obtained at each of the both ends of the capacitor 44 is an output voltage of the electric circuit 40. The low-side switching element 42 is inserted into a circuit including the inductor 43 and the capacitor 44 so as to be parallel with the DC power supply VB. The drain terminal of the switching element 42 is connected between the source terminal of the high-side switching element 41 and the inductor 43, and the source terminal of the switching element 42 is connected to the negative electrode of the DC power supply VB.

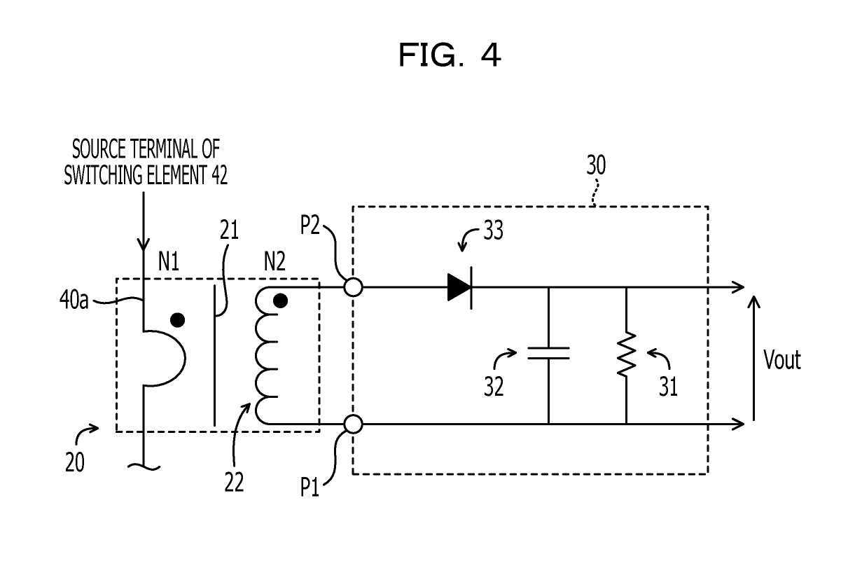

The winding part 20 of the current detection circuit 10 is fitted on the source terminal 40a of the low-side switching element 42. More specifically, the winding part 20 is provided on the low-side switching element 42 so that the source terminal 40a perforates through the through hole 21a of the bead core 21 (see FIGS. 1 and 2). Accordingly, the source terminal 40a of the low-side switching element 42 functions as a “primary winding of a winding number N1” and the lead wire 22 functions as a “secondary winding of a winding number N2” as illustrated in the equivalent circuit diagram of FIG. 4. That is, the winding part 20 functions as a current transformer including the bead core 21 provided as an iron core. In the above-described embodiment, the ratio between the winding number N1 and the winding number N2 (=N2/N1) has a value of about 5 to 10. However, the ratio value may not be limited to that of the above-described embodiment.

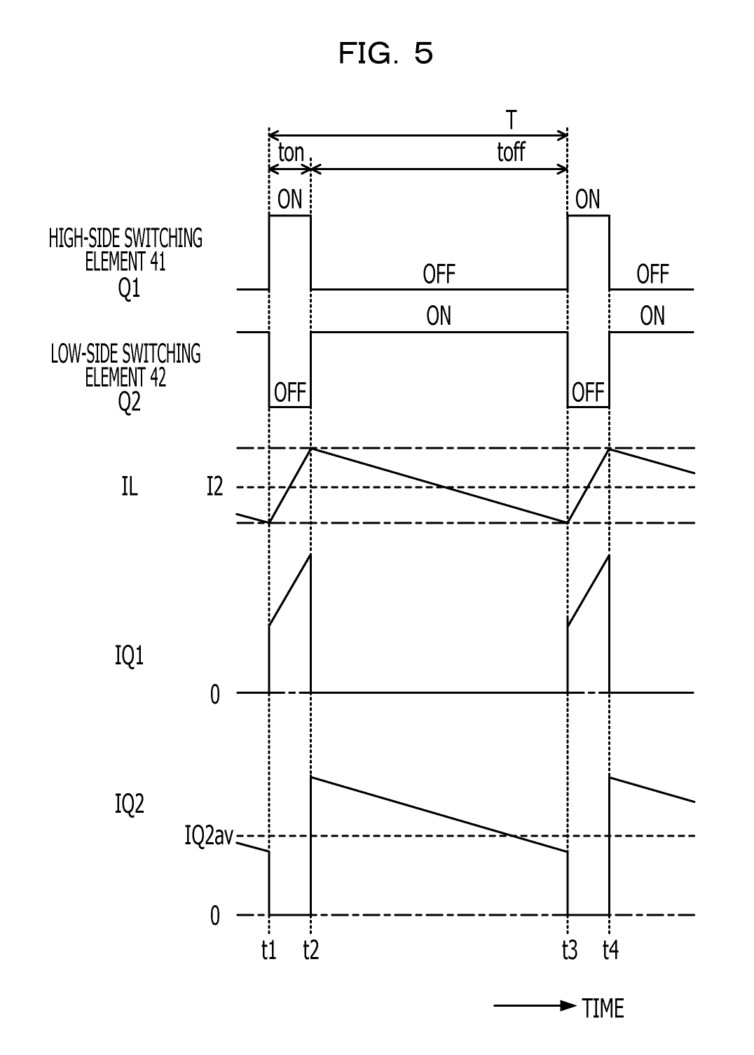

FIG. 5 is a time chart illustrating exemplary electric operations of the electric circuit 40 illustrated in FIG. 3. In the electric circuit 40, the state of the high-side switching element 41 is changed to the ON state and that of the low-side switching element 42 is changed to the OFF state at time t1. Further, at time t2 when a specified ON time ton had elapsed from time t1, the state of the high-side switching element 41 is changed to the OFF state and that of the low-side switching element 42 is changed to the ON state. Between time t1 and time t2 inclusive, a source current IQ1 passing through the high-side switching element 41 is increased in a step-like manner at time t1 and is further increased gradually. However, no source current IQ2 is fed into the low-side switching element 42 between time t1 and time t2 inclusive. As a consequence, a current IL passing through the inductor 43, that is, an inductor current is increased between time t1 and time t2 inclusive. An increment iu of the inductor current IL, which is attained between time t1 and time t2 inclusive, is expressed as ton·(V1−V2)/L.

Further, at time t3 when a specified OFF time toff had elapsed from time t2, the state of the high-side switching element 41 is again changed to the ON state and that of the low-side switching element 42 is changed to the OFF state. Between time t2 and time t3 inclusive, no source current IQ1 is fed into the high-side switching element 41 and the source current IQ2 passing through the low-side switching element 42 is increased in a step-like manner at time t2 and is decreased gradually. As a sequence, the inductor current IL is decreased between time t2 and time t3 inclusive. A decrement id of the inductor current IL, which is attained between time t2 and time t3 inclusive, is expressed as toff·V2/L.

The increment iu is equivalent to the decrement id in a steady state. Consequently, the output voltage V2 of the electric circuit 40 is determined and expressed as Equation (1) which is shown below. The sign T indicates the sum of the on time ton and the off time toff, which is a control period. Equation (1) clarifies that the output voltage V2 is changed based on a duty D (=ton/T). The electric circuit 40 includes a control unit (not shown) configured to determine the duty D so that the output voltage V2 becomes constant, and transmit a control signal to the gate terminal of each of the switching elements 41 and 42.

V2=V1·(ton/(ton+toff))=V1·ton/T (1)

Further, a current I2 output from the electric circuit 40 (i.e., the load current I2 fed into the load device 50) indicates the average value of the inductor current IL. Therefore, the output current I2 is substantially proportional (has significant correlation) to an average value IQ2av of the source current IQ2 (=drain current) passing through the low-side switching element 42.

A current which is proportional to the source current IQ2 is fed into the lead wire 22 of the winding part 20 included in the current transformer. The current is rectified (equalized) with the signal generation unit 30, and is obtained at each of the both ends of the resistor 31 as the voltage signal Vout. Accordingly, acquiring the magnitude of the voltage signal Vout through a voltmeter, AD conversion, etc. allows for acquiring a value correlating with a current passing through the low-side switching element 42. The acquired value has significant correlation to a current passing through the electric circuit 40 (which means the inductor current IL passing through part of the electric circuit 40 and the load current I2 in the above-described embodiment). Here, the “value having a correlation to the current” is a value which is changed based on a current for detection (e.g., a value which is roughly proportional to the current for detection) such as a current value of the current, a value obtained by converting the current into a voltage, and so forth. That is, the “value having a correlation to the current” is a value by which the magnitude of the current for detection can be uniquely determined.

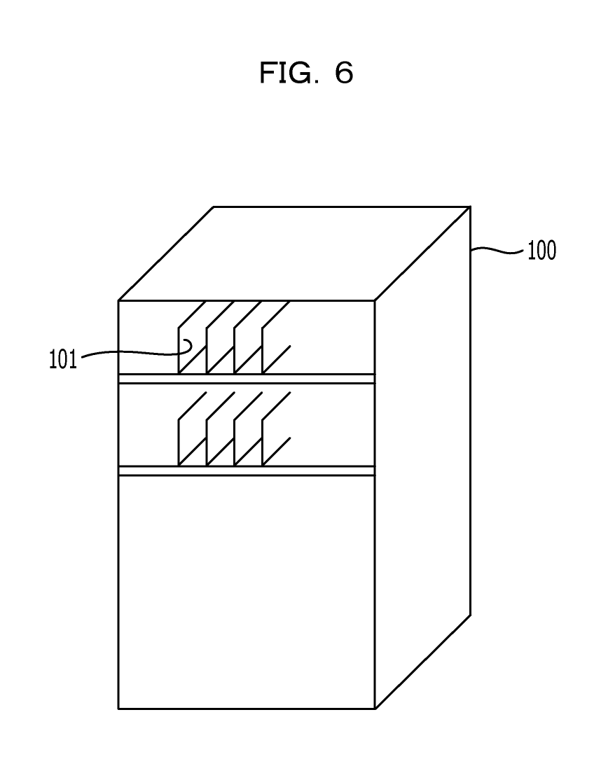

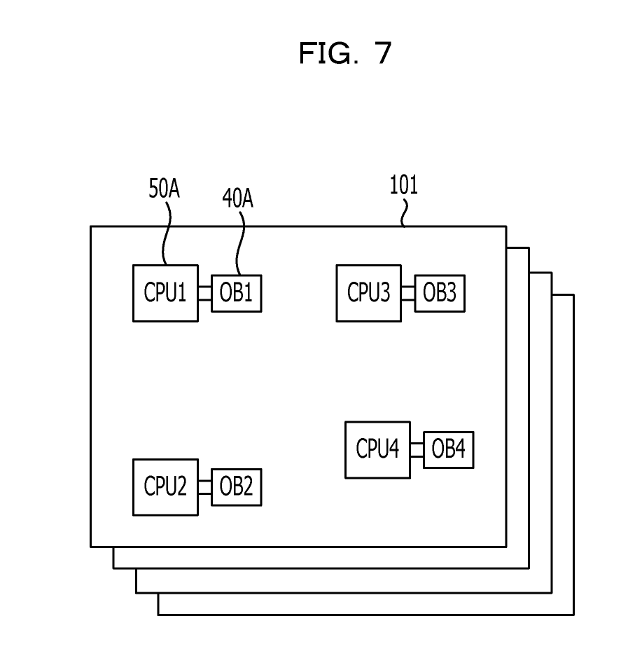

As illustrated in FIGS. 6 and 7, the current detection circuit 10 can be applied to a server 100 in which a plurality of print boards 101 is installed. Each of the print boards 101 includes a plurality of load devices 50A and a power supply device 40A configured to supply power to each of the load devices 50A. The power supply device 40A includes the above-described electric circuit (power supply circuit) 40 and current detection circuit 10. In the above-described server 100, the current detection circuit 10 detects the load current of the power supply device 40A, which is substantially lossless. Then, the detected load current is used to manage and/or control the server 100.

As described above, the current detection circuit 10 uses the bead core 21, which is originally provided on a switching element (the low-side switching element 42 in the above-described embodiment) to reduce power noises, as “part (core) of the winding part 20 of the current transformer”. Therefore, an additional new part which is specifically designed for the current transformer may not be provided in the electric circuit 40, which prevents the entire device including the electric circuit 40 from being increased in size. Further, it becomes possible to acquire the signal Vout with a value having a correlation to a current which is fed into the switching element (which means a signal with a value having a correlation to a current fed into the electric circuit 40) with less unnecessary power than that used for a current detection resistor.

Without being limited to the above-described embodiments, the present invention may be modified within the scope and spirit thereof. For example, when the bead core 21 is fitted on the source terminal of the high-side switching element 41, the lead wire 22 may be wound around the bead core 21 and a “signal with a value having a correlation to a current which is fed into the high-side switching element 41” may be retrieved based on a current passing through the lead wire 22.

Further, the current detection circuit 10 may be applied to a step-up DC-DC converter and an electric circuit other than a power supply circuit so long as the electric circuit includes a switching element on which the bead core 21 is provided. Additionally, the signal generation unit 30 may be a rectifier-and-smoothing circuit achieved in different form. Further, the signal generation unit 30 may only include a resistor so that a voltage signal obtained at each of both ends of the resistor is output. In that case, the voltage signal obtained at each of the both ends of the resistor may be subjected to AD conversion so that a plurality of voltage values (indicating the magnitude of the voltage signals) is acquired, and the acquired voltage values may be equalized through software so that a “value having a correlation to a current which is fed into a switching element (that is, the electric circuit 40)” is acquired.

Further, the above-disclosed current detection circuit 10 also functions as a device performing a current detection method for detecting a value having a correlation to a current fed into the “switching element on which the bead core 21 is provided”. According to the current detection method, the bead core 21 which is provided on the switching element is used as the core of the current transformer, the lead wire 22 wound around the bead core 21 is used as the secondary winding of the current transformer, and a value having a correlation to a “current passing through the switching element” is detected based on a current passing through the secondary winding. In other words, the above-described current detection method allows for detecting a “current passing through a switching element” by using the conductor part (terminal) of a switching element on which the bead core 21 is provided as the primary winding of a current transformer.

What is claimed is:

1. A current detection circuit comprising:
a winding part including a core provided on a switching element and a lead wire which is wound around the core; and
a signal generation unit configured to generate a signal with a value having a correlation to a current passing through the switching element based on a current passing through the lead wire.

2. The current detection circuit according to claim 1, wherein the signal generation unit includes a rectifier element connected in series with the lead wire, and a parallel circuit connected in series with the rectifier element, where the parallel circuit includes a resistor and a capacitor.

3. The current detection circuit according to claim 2, wherein the rectifier element is a diode.

4. A switching regulator circuit comprising:
a first switching element, a choke coil, and a smoothing capacitor that are connected in series with one another;
a second switching element that is connected in parallel with a series circuit including the choke coil and the smoothing capacitor and that is connected in parallel with the first switching element; and
a current detection circuit including a winding part including a core provided on the second switching element and a lead wire which is wound around the core, and a signal generation unit configured to generate a signal with a value having a correlation to a current passing through the second switching element based on a current passing through the lead wire.

5. The switching regulator circuit according to claim 4, wherein the signal generation unit includes a rectifier element connected in series with the lead wire, and a parallel circuit connected in series with the rectifier element, where the parallel circuit includes a resistor and a capacitor.

6. The switching regulator circuit according to claim 5, wherein the rectifier element is a diode.
